(19) United States
(12) Patent Application Publication
(10) Pub. No.: US 2004/0216834 A1
(43) Pub. Date: Nov. 4, 2004

(54) Track-labels, method of producing track labels and apparatus for their production

(76) Inventors: Matsuyoshi Ito, Aichi (JP); Takuya Nagao, Aichi (JP); Tatsuo Sawatari, Aichi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/480,257

(22) PCT Filed: Mar. 3, 2003
(86) PCT No.: PCT/JP03/02452

(51) Int. Cl. B32B 31/00; B32B 1/00; B31D 1/02

(52) U.S. Cl. 156/272.2; 156/277; 156/384; 428/40.1

(57) ABSTRACT

A photo-adhesive is locally printed onto a sheet for labels every after a predetermined interval, and is irradiated with light in a state of being shut off from the air so as to be imparted with stickiness; the photo-adhesive is printed in a state of not imparted with stickiness, and the adhered portions are locally formed every after a predetermined interval in a direction in which the sheet is fed; when irradiated with light in the air, however, the photo-adhesive does not produce so large adhesion and must, hence, be hermetically sealed; accordingly, the adhesive is hermetically sealed with a release sheet, and is irradiated with ultraviolet rays to produce stickiness; the sheet for labels or the release sheet is cut after every pattern of label that is printed; therefore, the sheet is not loosened, not wrinkled or forcibly oriented; the sheet and tack-labels are thus favorably produced.

### BACKGROUND OF THE INVENTION

1. Field of the Invention

The present invention relates to tack-labels, to a method of producing tack-labels and to an apparatus for their production. More specifically, the invention relates to improvements in the method of locally forming adhesion portions in a direction in which the sheet is fed or in the longitudinal direction of the sheet intermittently every after a predetermined interval, in the apparatus for their production and in the labels.

2. Description of the Related Art

So far, a single or a plurality of continuous adhesion lines has been formed on the whole surface of the sheet for labels in the longitudinal direction thereof. According to this conventional method, however, the adhesion portions could not be intermittently formed every after a predetermined interval in a direction in which the sheet is fed or in the longitudinal direction of the sheet. The adhesion portions are sticky. Therefore, if the adhesive is intermittently applied to the sheet in a direction in which the sheet is fed or in the longitudinal direction thereof, the sheet is loosened, wrinkled or is forcibly oriented (including stretched), and the sheet and tack-labels are not favorably produced.

Therefore, the applicant has contrived the following. Namely, as shown in FIGS. 9 and 10, an adhesion layer 33 is continuously formed in advance on the lower surface of the sheet (tack-labels/label base materials) 32 from which the labels are to be produced, and a masking layer (non-adhesive masking layer/masking adhesive) 36 is printed maintaining a predetermined interval on the adhesion layer 33 to conceal the adhesive function of the adhesion layer 33. The sheet 32 (including substrate, tack-labels and label base materials) for labels is intimately adhered onto a release sheet (including peeling off mount, liner, release liner and cement sheet) 34. A certain kind of the masking layer 36 is cured by the irradiation with ultraviolet rays etc.

Being covered with the masking layer 36, however, the adhesion layer 33 that is formed becomes wasteful. Besides, the masking layer 36 must be used. With the adhesion layer 33 being mostly covered with the masking layer 36 as shown in FIGS. 9 and 10, a majority proportion of the adhesion layer 33 is wasted.

### SUMMARY OF THE INVENTION

According to the present invention, therefore, attention is given to using a photo-adhesive. This makes it possible to print the adhesive in a state where the adhesive is not acquiring the stickiness, and the adhesion portions can be formed on the sheet in a direction in which the sheet is fed or in the longitudinal direction thereof every after a predetermined interval. However, the photo-adhesive fails to produce the stickiness to a sufficient degree if it is irradiated with light in the air. The inventors, therefore, have forwarded the study in an attempt to irradiate the adhesive with light after it is hermetically sealed.

According to the present invention, a pattern of the label is printed every after a predetermined interval, and the photo-adhesive without stickiness is locally printed every after a predetermined interval depending on the size of the label. If a release sheet is intimately adhered onto the surface of the sheet for labels on which the photo-adhesive has been printed, then, the photo-adhesive that is printed is shut off from oxygen in the air. The photo-adhesive is irradiated with light to impart stickiness thereto, and the sheet for labels or the release sheet is cut after every pattern of the label that is printed. Thus, the sheet is not loosened, is not wrinkled or is not forcibly oriented, making it possible to favorably produce the sheet and the tack-labels.

### BRIEF DESCRIPTION OF THE DRAWINGS

FIG. 1 illustrates a method and an apparatus for printing an ink layer 16 on the back surface side of the tack-labels 1.

FIG. 2 illustrates a method and an apparatus for printing the ink layer 16 on the front surface side of the tack-labels 1.

FIG. 3 illustrates a method and an apparatus for producing tack-labels 1 of when a sheet 2 for labels and a release sheet (including liner, release liner and cement sheet) 4 are opaque.

FIG. 4 illustrates a sectional structure of the tack-label 1 produced by the method of FIG. 2.

FIG. 5 illustrates a sectional structure of the tack-label 1 produced by the method of FIG. 1 or 3.

FIG. 6 illustrates a plane structure of the tack-label 1 produced by the methods of FIGS. 1 to 3.

FIG. 7 illustrates the experimental results of a correlation between the amount of the ultraviolet ray irradiation and the adhesion (including sticking force) of when a photo-adhesive 3 is hermetically sealed and when the photo-adhesive 3 is not hermetically sealed.

FIG. 8 illustrates the experimental results of a correlation between the amount of the ultraviolet ray irradiation and the change in the adhesion with the passage of time of when the photo-adhesive 3 is hermetically sealed.

FIG. 9 illustrates a sectional structure of the tack-label that uses a masking layer 36.

FIG. 10 illustrates a plane structure of the tack-label that uses the masking layer 36.

### DESCRIPTION OF THE PREFERRED EMBODIMENTS

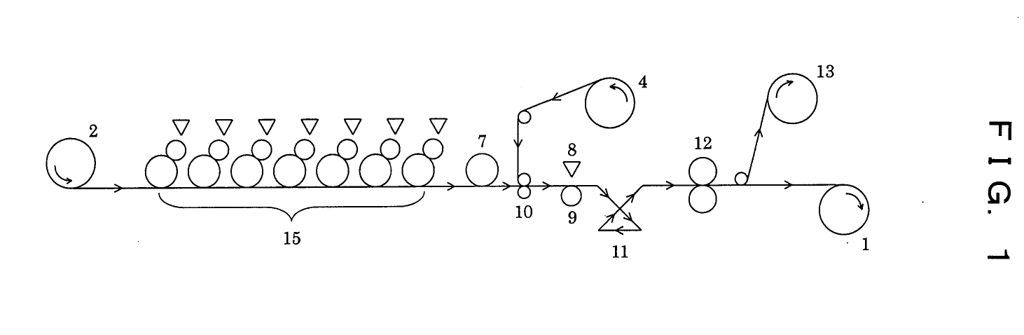

(1) Method and Apparatus for Producing Tack-labels 1 (FIG. 1)

FIG. 1 illustrates a first embodiment of a method and an apparatus for producing tack-labels 1. In this embodiment, a sheet 2 for labels (including substrate, tack-labels and label base materials) is opaque or transparent, and a release sheet 4 (including peeling off mount, liner, release liner and cement sheet) is transparent and permits light to pass through. Onto the back surface of the sheet 2 for labels, there are laminated an ink layer 16 (including printing pattern of label) in a pattern of the label, a photo-adhesive 3 (including photo-adhesive layer) and the release sheet 4 in this order.

The sheet 2 for labels is of a single form, which is long, is wound on a roller like a roll, and is drawn successively. The roller on which the sheet 2 for labels is wound is passive having a small rotational friction, and easily rotates as the sheet 2 for labels is drawn. The roller may not be passive but may be active being driven by a motor. The sheet 2 for labels is an opaque film that does not permit light to pass through or is a transparent film that permits light to pass through. The light may include ultraviolet rays, visible rays or electron beams as will be described later.

Inks of patterns of a plurality of colors are printed successively and in an overlapped manner on the back surface of the sheet 2 for labels that is drawn by using a plurality of multi-color ink print rollers 15 (including ink printing device and flexography printing device). Thus, the pattern of the tack-label is printed every after a predetermined interval. The label-printing pattern is printed on the back surface of the sheet 2 for labels from the upper side in FIG. 1.

The sheet 2 for labels on which color inks (inclusive of white, black and gray) are printed passes through an adhesive pattern print roller 7 (including adhesive printing device and flexography printing device) which locally applies the photo-adhesive 3 without having stickiness thereto every after a predetermined interval depending upon the size of the label. Upon being irradiated with light or a medium belonging to light, such as ultraviolet rays (UV), visible rays or electron beams, the photo-adhesive 3 turns into a sticky state. The photo-adhesive 3 is printed onto the back surface of the sheet 2 for label from the upper side in FIG. 1. The interval for printing the photo-adhesive 3 and the interval for printing the color inks are equal to each other or in a relationship of an integer number of times.

The release sheet 4 is long and is wound on a roller like a roll, and is drawn successively. The roller on which the release sheet 4 is wound is passive having a small rotational friction, and easily rotates as the release sheet 4 is drawn. The roller may not be passive but may be active being driven by a motor. The release sheet 4 is a transparent film that permits light to pass through. The light may include ultraviolet rays, visible rays or electron beams as will be described later.

The release sheet 4 that is drawn is pressed and intimately adhered onto the back surface of the sheet 2 for labels through nipping rollers 10 (including pressing and cementing rollers), and the photo-adhesive 3 is completely shut off from the air or oxygen. The sheet 2 for labels to which the release sheet 4 is intimately adhered, is irradiated on a chill roller 9 (including cooling roller) with light from an ultraviolet ray lamp 8 (including ultraviolet rays irradiation device). Then, the photo-adhesive 3 that is hermetically sealed produces stickiness. Due to this irradiation, the adhesive 3 undergoes the polymerization reaction and cross-linking reaction so as to become sticky.

Then, the sheet 2 for labels and the release sheet 4 are reversed front side back by a turn bar 11 (reverse device), and is half-cut through a half-die-cut device 12 (including die cut roller and half-cut rapping device) in a manner that the release sheet 4 and the tack-labels 1 only are left. That is, the sheet 2 for labels up to the photo-adhesive 3 or, further, up to the color ink layers is half-cut. The release sheet 4 that is half-cut and on which the tack-labels 1 are cemented, is taken up by a roller as a sheet of tack-labels 1. The remaining sheet 2 for labels is taken up by a waste roller 13 (including trash roller, rubbish roller, trash stripping rubbish stripping and waste stripping).

The waste roller 13 and the roller for taking up the sheet of tack-labels 1 are active being driven by motors. The half-die-cut device 12 cuts the sheet 2 for labels and the release sheet 4 every after a predetermined interval or for each of the patterns of the tack-labels 1.

The ink of the label pattern to be printed may contain an ultraviolet ray-shielding agent. Or, the ultraviolet ray-shielding agent may be applied onto the above ink. Or, an ultraviolet ray-shielding sheet may be adhered thereon. Further, the ultraviolet ray-shielding sheet may be adhered onto the sheet 2 for labels or onto the release sheet 4, or the ultraviolet ray-shielding agent may be applied onto these sheets 2 and 4, or these sheets 2 and 4 may be blended with the ultraviolet ray-shielding agent.

Therefore, the colors of inks printing the patterns of tack-labels 1 and the ink films (including ink layers) are prevented from being discolored, deteriorated and degenerated, or the sheet 2 itself for labels or the release sheet 4 itself is prevented from being discolored, deteriorated and degenerated by ultraviolet rays. Further, the substance such as liquid medicine in a container to which the transparent tack-label 1 (including sheet 2 for labels) is stuck, is prevented from being deteriorated and degenerated by ultraviolet rays, and the liquid medicine is protected. The printing/the applying adhesive/the cementing is accomplished by a UV-cut printing roller 14 (including light-shielded applying device) that will be described later.

The ultraviolet ray lamp 8 may emit light not from the upper side of the release sheet 4 ( ) but from the lower side of the sheet 2 for labels. In this case, the photo-adhesive 3 is so printed as will not be overlapped on the portions on where the color inks are printed, so that the sheet 2 for labels is maintained transparent. In this case, the release sheet 4 may be opaque which does not permit the passage of light. The sheet 2 for labels, in this case, is a transparent film that permits the passage of light. As described above, the light includes ultraviolet rays, visible rays and electron beams.

The rotational amounts of the rollers (rotational angles of motors) and the feeding amounts of the sheet 2 for labels and/or the release sheet 4, are brought into synchronism and harmony by optical sensors and the like, and their rotational amounts and the feeding amounts are uniformed, so that the sheets 2 and 4 will not be loosened, wrinkled or forcibly oriented (including stretched). The rollers are rotatively supported in the apparatus for producing tack-labels. In the turn bar 11, the rollers are fitted to the sheet 2 for labels and to the release sheet 4 being tilted at an angle of 45 degrees thereto, so that the sheets 2 and 4 are reversed backside front in the transverse direction by 90 degrees, or are folded upward and reversed through the two rollers.

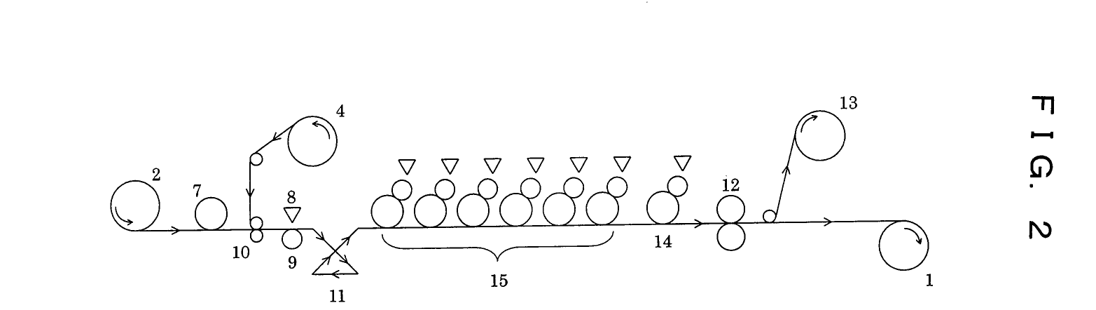

(2) Method and Apparatus for Producing Tack-labels 1 (FIG. 2)

FIG. 2 illustrates a second embodiment of the method and the apparatus for producing tack-labels 1. In this embodiment, the sheet 2 for labels is opaque or transparent, and the release sheet 4 is transparent and permits light to pass through. Ink is laminated in a pattern of labels on the front surface of the sheet 2 for labels. Onto the back surface of the sheet 2 for labels, there are laminated the photo-adhesive 3 and the release sheet 4 in this order.

The sheet 2 for labels is of a single form, which is long, is wound on a roller like a roll, and is drawn successively. The roller on which the sheet 2 for labels is wound is passive having a small rotational friction, and easily rotates as the sheet 2 for labels is drawn. The roller may not be passive but may be active being driven by a motor. The sheet 2 for labels is an opaque film that does not permit light to pass through or is a transparent film that permits light to pass through. The light may include ultraviolet rays, visible rays or electron beams as will be described later.

The photo-adhesive 3 without stickiness is locally applied every after a predetermined interval depending upon the size of the labels by using an adhesive pattern print roller 7. Upon being irradiated with light or a medium belonging to light, such as ultraviolet rays (UV), visible rays or electron beam, the photo-adhesive 3 turns into a sticky state. The photo-adhesive 3 is printed onto the back surface of the sheet 2 for label from the upper side in FIG. 2.

The release sheet 4 is long and is wound on a roller like a roll, and is drawn successively. The roller on which the release sheet 4 is wound is passive having a small rotational friction, and easily rotates as the release sheet 4 is drawn. The roller may not be passive but may be active being driven by a motor. The release sheet 4 is a transparent film that permits light to pass through.

The release sheet 4 that is drawn is pressed and intimately adhered/cemented/laminated onto the back surface of the sheet 2 for labels through nipping rollers 10, and the photo-adhesive 3 is completely shut off from the air or oxygen. The sheet 2 for labels to which the release sheet 4 is intimately adhered, is irradiated on a chill roller 9 with light from the ultraviolet ray lamp 8. Then, the photo-adhesive 3 that is hermetically sealed produces stickiness. Due to this irradiation, the photo-adhesive 3 undergoes the polymerization reaction and cross-linking reaction so as to become sticky.

Then, the sheet 2 for labels and the release sheet 4 are reversed front side back by the turn bar 11. Inks of patterns of a plurality of colors are printed successively and in an overlapped manner on the back surface of the sheet 2 for labels that has the release sheet 4 adhered onto the back surface thereof by using a plurality of multi-color ink print rollers 15. Thus, the pattern of the tack-label is printed every after a predetermined interval. The label-printing pattern is printed on the front surface of the sheet 2 for labels from the upper side in FIG. 2. The interval for printing the color inks and the interval for printing the photo-adhesive 3 are equal to each other or in a relationship of an integer number of times.

A light-shielding agent is printed onto the sheet 2 for labels on which color inks (inclusive of white, black and gray) are printed and onto the release sheet 4 by using a UV-cut print roller 14. The light-shielding agent shuts off the ultraviolet rays, whereby the colors of inks printing the patterns of tack-labels 1 and the ink films are prevented from being discolored and deteriorated and degenerated, or the sheet 2 itself for labels or the release sheet 4 itself is prevented from being discolored and degenerated and deteriorated by ultraviolet rays, and are protected. Further, the substance such as liquid medicine in a container to which the transparent tack-label 1 (sheet 2 for labels) is stuck, is prevented from being deteriorated by ultraviolet rays, and the liquid medicine is protected.

Then, the sheet 2 for labels is half-cut through the half-die-cut device 12 in a manner that the release sheet 4 and the tack-labels 1 only are left. That is, the sheet 2 for labels up to the photo-adhesive 3 or, further, up to the color ink layers is half-cut. The release sheet 4 that is half-cut and on which the tack-labels 1 are cemented, is taken up by a roller as a sheet of tack-labels 1. The remaining sheet 2 for labels is taken up by the waste roller 13.

The waste roller 13 and the roller for taking up the sheet of tack-labels 1 are active being driven by motors. The half-die-cut device cuts the sheet 2 for labels and the release sheet 4 every after a predetermined interval or for each of the patterns of the tack-labels 1.

The ink of the label pattern to be printed may contain an ultraviolet ray-shielding agent. Or, the ultraviolet ray-shielding agent may be applied onto the above ink. Or, an ultraviolet ray-shielding sheet may be adhered thereon. Further, the ultraviolet ray-shielding sheet may be adhered onto the sheet 2 for labels or onto the release sheet 4, or the ultraviolet ray-shielding agent may be applied onto these sheets 2 and 4, or these sheets 2 and 4 may be blended with the ultraviolet ray-shielding agent.

Therefore, the colors of inks printing the patterns of tack-labels 1 and the ink films are prevented from being discolored, deteriorated and degenerated, or the sheet 2 itself for labels or the release sheet 4 itself is prevented from being discolored and deteriorated, degenerated by ultraviolet rays. Further, the substance such as liquid medicine in a container to which the transparent tack-label 1 (sheet 2 for labels) is stuck, is prevented from being deteriorated and degenerated by ultraviolet rays, and the liquid medicine is protected. The printing/the applying adhesive/the cementing is accomplished by a UV-cut printing roller 14 that will be described later.

Further, the ultraviolet ray lamp 8 may emit light not from the upper side of the release sheet 4 but from the upper side of the sheet 2 for labels. In this case, the sheet 2 for labels becomes transparent. The ultraviolet ray lamp 8, in this case, may be provided after the turn bar 11, ink print rollers 15 or the UV-cut print roller 14. The release sheet 4 may be opaque which does not permit the passage of light.

The rotational amounts of the rollers (rotational angles of motors) and the feeding amounts of the sheet 2 for labels and/or the release sheet 4, are brought into synchronism and harmony by optical sensors and the like, and their rotational amounts and the feeding amounts are uniformed, so that the sheets 2 and 4 will not be loosened, wrinkled or forcibly oriented (including stretched). The rollers are rotatively supported in the apparatus for producing tack-labels. In the turn bar 11, the rollers are fitted to the sheet 2 for labels and to the release sheet 4 being tilted at an angle of 45 degrees thereto, so that the sheets 2 and 4 are reversed backside front in the transverse direction by 90 degrees, or are folded upward and reversed through the two rollers.

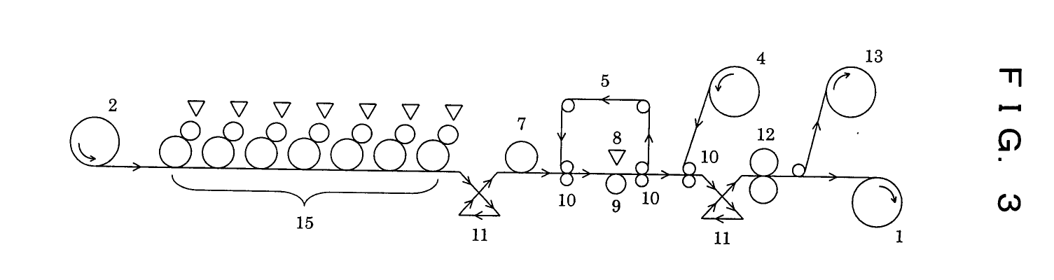

(3) Method and Apparatus for Producing Tack-labels 1 (FIG. 3)

FIG. 3 illustrates a third embodiment of the method and the apparatus for producing tack-labels 1. In this embodiment, the sheet 2 for labels and the release sheet 4 are opaque and do not permit light to pass through. Ink is laminated in a pattern of labels on the front surface of the sheet 2 for labels. Onto the back surface of the sheet 2 for labels, there are laminated the photo-adhesive 3 and the release sheet 4 in this order.

The sheet 2 for labels is of a single form which is long, is wound on a roller like a roll, and is drawn successively. The roller on which the sheet 2 for labels is wound is passive having a small rotational friction, and easily rotates as the sheet 2 for labels is drawn. The roller may not be passive but may be active being driven by a motor. The sheet 2 for labels is an opaque film that does not permit light to pass through.

Inks of patterns of a plurality of colors are printed successively and in an overlapped manner on the sheet 2 for labels that is drawn by using a plurality of multi-color ink print rollers 15. Thus, the pattern of the tack-label is printed every after a predetermined interval. The label-printing pattern is printed on the back surface of the sheet 2 for labels from the upper side in FIG. 3.

The sheet 2 for labels on which color inks (inclusive of white, black and gray) are printed, are reversed front side back by the turn bar 11, and passes through an adhesive pattern print roller 7 which locally applies the photo-adhesive 3 without having stickiness thereto every after a predetermined interval depending upon the size of the label. Upon being irradiated with light or a medium belonging to light, such as ultraviolet rays (UV), visible rays or electron beams, the photo-adhesive 3 turns into a sticky state. The photo-adhesive 3 is printed onto the back surface of the sheet 2 for label from the upper side in FIG. 1. The interval for printing the photo-adhesive 3 and the interval for printing the color inks are equal to each other or in a relationship of an integer number of times.

A sub-release sheet 5 (including peeling off mount, liner, release liner and cement sheet) for pre-adhesion is in an endless form running around a plurality of rollers, and circulates in an endless manner. The rollers for the sub-release sheet 5 for pre-adhesion are passive having a small rotational friction, and easily rotate as the release sheet 4 is drawn. The rollers may not be passive but may be active being driven by a motor. The sub-release sheet 5 for pre-adhesion can be peeled off, and is a transparent film that permits light to pass through. The light may include ultraviolet rays, visible rays or electron beams as will be described later.

The sub-release sheet 5 for pre-adhesion that is drawn is pressed and intimately adhered/cemented/laminated onto the back surface of the sheet 2 for labels through the nipping rollers 10, and the photo-adhesive 3 is completely shut off from the air or oxygen. The sheet 2 for labels to which the sub-release sheet 5 for pre-adhesion is intimately adhered, is irradiated on the chill roller 9 with light from the ultraviolet ray lamp 8. Then, the photo-adhesive 3 that is hermetically sealed produces stickiness. Due to this irradiation, the adhesive 3 undergoes the polymerization reaction and cross-linking reaction so as to become sticky.

Then, the sub-release sheet 5 for pre-adhesion is peeled off from the sheet 2 for labels by the nipping rollers 10, and circulates like a loop to repeat the intimate adhesion and released. The endless sub-release sheet 5 for pre-adhesion has a length which is just an integer number of times as long as the interval between applying the photo-adhesive 3 or applying the color inks. Therefore, the photo-adhesive 3 that is becoming sticky comes in contact with the same portion of the endless sub-release sheet 5 for pre-adhesion at all times, but is not transferred to different positions of the sheet 2 for labels.

The release sheet 4 is long and is wound on a roller like a roll, and is drawn successively. The roller on which the release sheet 4 is wound is passive having a small rotational friction, and easily rotates as the release sheet 4 is drawn. The roller may not be passive but may be active being driven by a motor. The release sheet 4 is an opaque film that does not permit light to pass through.

The release sheet 4 that is drawn is pressed and intimately adhered/cemented/laminated onto the back surface of the sheet 2 for labels through the nipping rollers 10, and the photo-adhesive 3 is completely shut off from the air or oxygen. The sheet 2 for labels to which the release sheet 4 is intimately adhered, is reversed front side back by the turn bar 11, and is half-cut through the half-die-cut device 12 in a manner that the release sheet 4 and the tack-labels 1 only are left. That is, the sheet 2 for labels up to the photo-adhesive 3 or, further, up to the color ink layers is half-cut. The release sheet 4 that is half-cut and on which the tack-labels 1 are cemented, is taken up by a roller as a sheet of tack-labels 1. The remaining sheet 2 for labels is taken up by the waste roller 13.

The waste roller 13 and the roller for taking up the sheet of tack-labels 1 are active being driven by motors. The half-die-cut device 12 cuts the sheet 2 for labels and the release sheet 4 every after a predetermined interval or for each of the patterns of the tack-labels 1.

The ink of the label pattern to be printed may contain an ultraviolet ray-shielding agent. Or, the ultraviolet ray-shielding agent may be applied onto the above ink. Or, an ultraviolet ray-shielding sheet may be adhered thereon. Further, the ultraviolet ray-shielding sheet may be adhered onto the sheet 2 for labels or onto the release sheet 4, or the ultraviolet ray-shielding agent may be applied onto these sheets 2 and 4, or these sheets 2 and 4 may be blended with the ultraviolet ray-shielding agent.

Therefore, the colors of inks printing the patterns of tack-labels 1 and the ink films are prevented from being discolored, deteriorated and degenerated, or the sheet 2 itself for labels or the release sheet 4 itself is prevented from being discolored, deteriorated and degenerated by ultraviolet rays, and these colors, films, sheets 2 and 4 are protected. Further, the substance such as liquid medicine in a container to which the transparent tack-label 1 (sheet 2 for labels) is stuck, is prevented from being deteriorated and degenerated by ultraviolet rays, and the liquid medicine is protected. The printing/the applying adhesive/the cementing is accomplished by the UV-cut printing roller 14 described above.

The sub-release sheet 5 for pre-adhesion may not be endless but maybe lengthily wound on the feed roller, delivered from the feed roller, intimately adhered onto the sheet 2 for labels from the nipping rollers 10 up to the peel rollers 10, and may, then, be taken up by a take-up roller.

The rotational amounts of the rollers (rotational angles of motors) and the feeding amounts of the sheet 2 for labels and the release sheet 4 and/or the sub-release sheet 5 for pre-adhesion, are brought into synchronism and harmony by optical sensors and the like, and their rotational amounts and the feeding amounts are uniformed, so that the sheets 2 and 4 will not be loosened, wrinkled or forcibly oriented. The rollers are rotatively supported in the apparatus for producing tack-labels. In the turn bar 11, the rollers are fitted to the sheet 2 for labels and to the release sheet 4 being tilted at an angle of 45 degrees thereto, so that the sheets 2 and 4 are reversed backside front in the transverse direction by 90 degrees, or are folded upward and reversed through the two rollers.

(4) Sectional Structure of the Tack-label 1 (Production Method of FIG. 2)

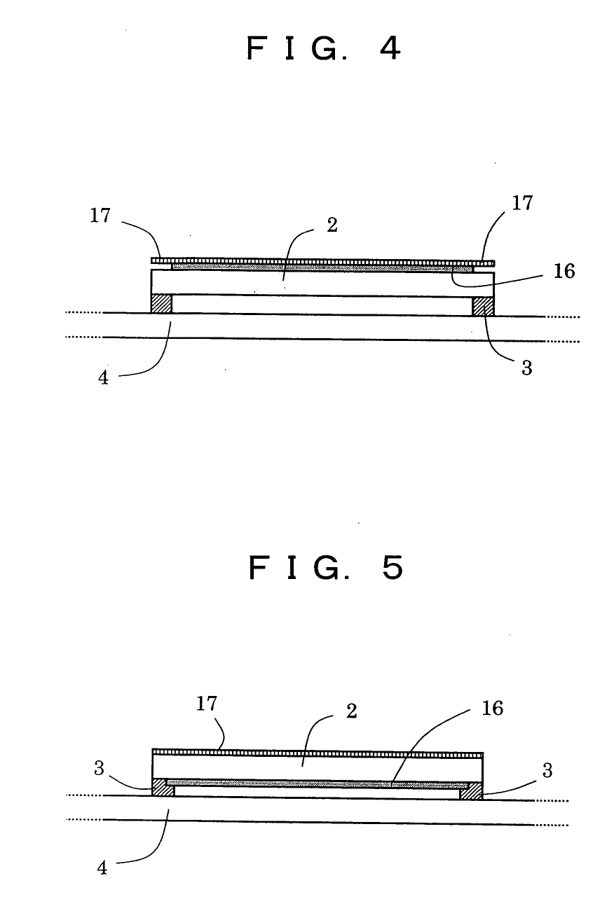

FIG. 4 illustrates a sectional structure of the tack-label 1 produced by the production apparatus and method shown in FIG. 2. The photo-adhesive 3 is printed on the lower surface (back surface) of the sheet 2 for labels by the adhesive pattern print roller 7, and the release sheet 4 is cemented under the photo-adhesive.

An ink layer 16 (including printing pattern of label) is printed on the upper surface (front surface) of the sheet 2 for labels by the ink print roller 15. An ultraviolet ray shut-off layer 17 is printed/applied/cemented on the upper surface of the ink layer 16 by the UV-cut print roller 14. Therefore, the surface on which the ink layer 16 of the tack-label 1 or the pattern is printed is different from the surface on which the photo-adhesive 3 is printed.

With the ink layer 16 and the photo-adhesive 3 being printed on the front and back surfaces each, then, it is allowed to see the surface of the container on which the tack-label 1 is printed from the front surface side.

(5) Sectional Structure of the Tack-label 1 (Production Method of FIG. 1 or 3)

FIG. 5 illustrates a sectional structure of the tack-label 1 produced by the production apparatus and method shown in FIG. 1 or 3. The ink layer 16 is printed on the upper surface (front surface) or the lower surface (back surface) of the sheet 2 for labels by the ink print roller 15. The photo-adhesive 3 is printed on the lower surface of the ink layer 16 or on the lower surface (back surface) of the sheet 2 for labels by the adhesive pattern print roller 7.

The release sheet 4 is cemented under the photo-adhesive. An ultraviolet ray shut-off layer 17 is printed on the upper surface (front surface) of the sheet 2 for labels by the UV-cut print roller 14. Therefore, the surface on which the ink layer 16 of the tack-label 1 or the pattern is printed, is the same as, or is different from, the surface on which the photo-adhesive 3 is printed.

When the ink layer 16 and the photo-adhesive 3 are printed on the same back surface, then, it is allowed to see the printed tack-label 1 from the back surface side through the transparent container when the side of the ink layer 16 and the photo-adhesive 3 are stuck to the surface of the transparent container. Besides, the sheet 2 for labels is playing the role of a coating layer that protects the ink layer 16, and no coating layer is needed for protecting the ink layer 16 unlike that of when the ink layer 16 is printed on the front surface. This also holds true even for the tack-label 1 produced by the production method shown in FIG. 1.

Referring to FIGS. 1 to 3, the ink print rollers 15 may be provided for both the back surface and the front surface of the sheet 2 for labels. Then, the printed surface can be seen from either the front side or the backside of the tack-label 1.

(6) Plane Structure of the Tack-label 1

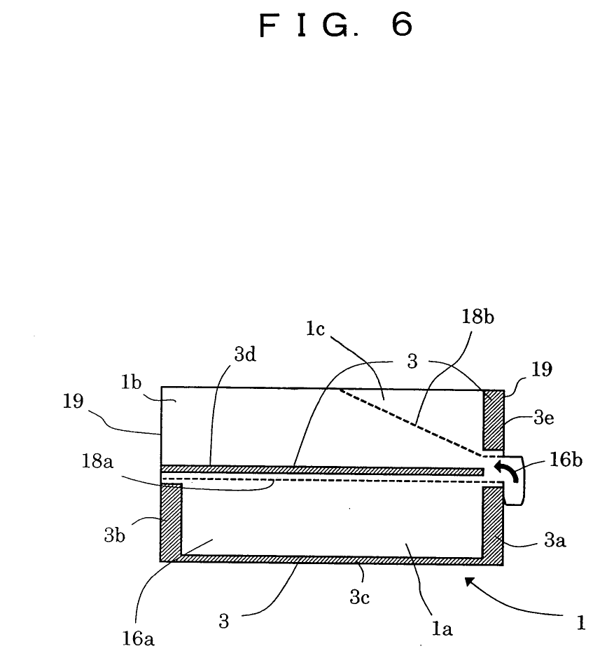

FIG. 6 illustrates the plane structure of the tack-label 1 produced by the production apparatuses and the methods of FIGS. 1 to 3. Square and arrow-like ink layers 16 are printed on the front surface or on the back surface of the transparent sheet 2 for labels by the ink print roller 15.

On the square ink layer 16a, there are printed the name of product, name of the manufacturer, name of the distributor, effect, components, content, notice, etc. If the arrow-like ink layer 16b is nipped and pulled, an break-the-seal portion 1b and a portion 1c coupled to the break-the-seal portion constituting the upper half of the tack-label 1 are separated and peeled off from the main portion 1a constituting the lower half along a central perforation 18a and an upwardly tilted perforation 18b.

The central perforation 18a and the upwardly tilted perforation 18b can be formed simultaneously when the half-cut is effected by the half-die-cut device 12. Besides, a cutting line 19 surrounding the tack-label 1 is formed by the half-cutting.

On both the right and left ends of the main portion 1a which is the lower half of the tack-label 1, the photo-adhesive 3 is printed by the adhesive pattern print roller 7 onto a right lower adhesion layer 3a and onto a left lower adhesion layer 3b. On the lower edge of the main portion 1a of the tack-label 1, further, the photo-adhesive 3 is printed by the adhesive pattern print roller 7 to form a lower edge adhesion layer 3c.

On the lower edge of the break-the-seal portion 1b which is the upper half of the tack-label 1, the photo-adhesive 3 is printed by the adhesive pattern print roller 7 to form a lower edge adhesion layer 3d of an upper part. The photo-adhesive 3 is printed by the adhesive pattern print roller 7 onto the right end of the portion 1c coupled to the break-the-seal portion, which is a triangular portion at the right in the upper half portion of the tack-label 1, thereby to form a right upper adhesion layer 3e.

The right lower adhesion layer 3a, left lower adhesion layer 3b and right upper adhesion layer 3e are thickly formed compared to the lower edge adhesion layer 3c and lower edge adhesion layer 3d of the upper part, and produce large adhering force. The break-the-seal portion 1b and the portion 1c coupled to the break-the-seal portion can be easily peeled off overcoming the adhering force of the lower edge adhesion layer 3d of the upper part.

When the tack-label 1 is stuck to the container, the right lower adhesion layer 3a is adhered being overlapped on the left lower adhesion layer 3b and, hence, the main portion 1a which is the lower half portion is strongly stuck to the container. On the other hand, no adhesion layer is formed at the left end of the break-the-seal portion 1b and, hence, the break-the-seal portion 1b can be easily peeled off from the container. Besides, the right upper adhesion layer 3e at the right end of the portion 1c coupled to the break-the-seal portion is adhered being overlapped on the left end of the break-the-seal portion 1b. Therefore, the portion 1c coupled to the break-the-seal portion is integrally peeled off being coupled to the break-the-seal portion 1b.

The container to which the tack-label 1 is stuck has the shape of a circular pole, square pole, circular cylinder or square cylinder. Therefore, the tack-label 1 is stuck to the surface of the circular pole, square pole, circular cylinder or square cylinder.

The break-the-seal portion 1b and the portion 1c coupled to the break-the-seal portion of the tack-label 1 are stuck being wound on a cap portion of the container, and the main portion 1a of the tack-label 1 is stuck being wound on the barrel portion of the container. Depending upon whether the break-the-seal portion 1b and the portion 1c coupled to the break-the-seal portion is peeled off or not, therefore, it can be judged whether the container has not been opened or opened.

The tack-labels 1 are formed in a plurality of rows on the sheet 2 for labels and on the release sheet 4 maintaining a predetermined interval in the direction of width, and are formed in many number successively maintaining the predetermined interval on the sheet 2 for labels and on the release sheet 4 in a direction in which they are fed or longitudinal direction (horizontal direction in FIG. 6).

Therefore, the right lower adhesion layer 3a, left lower adhesion layer 3b, right upper adhesion layer 3e, lower edge adhesion layer 3c and lower edge adhesion layer 3d of the upper portion, are locally applied in the direction in which the sheets 2 and 4 are fed or longitudinal direction maintaining a predetermined interval depending upon the size of the tack-labels 1. The ink layers 16a and 16b, too, are locally applied in the direction in which the sheets 2 and 4 are fed maintaining a predetermined interval depending upon the size of the tack-labels 1. The lower edge adhesion layer 3c and the lower edge adhesion layer 3d of the upper portion can be omitted depending upon the cases.

The method of the present invention is particularly effective when the adhesion layers are printed orienting in nearly the direction of the width of the sheets 2 and 4 or orthogonally (intersect) right direction of the longitudinal direction, like the right lower adhesion layer 3a, left lower adhesion layer 3b and right upper adhesion layer 3e, preventing the sheets 2 and 4 from loosened, wrinkled or forcibly oriented.

The method of the present invention is particularly effective even when the length or area of a portion where photo-adhesive 3 formed is smaller than the length or area of a portion where the photo-adhesive 3 has not been formed in the direction in which the sheets 2 and 4 are fed or longitudinal direction, preventing the sheets 2 and 4 from loosened, wrinkled or forcibly oriented. In this case, the tack-labels 1 are regularly arranged along the direction in which the sheets 2 and 4 are fed or longitudinal direction. The tack-labels 1, however, may be deviated by a small amount without causing any problem.

Further, the method of the present invention is particularly effective even when the length or area of a portion where photo-adhesive 3 is formed is larger than the length or area of a portion where the photo-adhesive 3 has not been formed in nearly the direction of width of the sheets 2 and 4 (including the direction in which the sheets 2 and 4 are fed or longitudinal direction), preventing the sheets 2 and 4 from loosened, wrinkled or forcibly oriented. In this case, the tack-labels 1 are regularly arranged along the direction of width of the sheets 2 and 4. The tack-labels 1, however, may be deviated by a small amount without causing any problem.

The right lower adhesion layer 3a, left lower adhesion lawyer 3b, right upper adhesion layer 3e, lower edge adhesion layer 3c and/or lower edge adhesion layer 3d of the upper portion, are formed in contact with the boundary or cutting line 19 that will be cut along the peripheral edge of the tack-label 1, and the photo-adhesive 3 is applied onto the back surface only on the inside of the portions that are to be cut. Therefore, the sheet 2 for labels that are taken up by the waste roller, is easily peeled off from the release sheet 4 and the tack-labels 1 that are half-cut by the half-die-cut device 12, and the tack-label 1 that is stuck is not easily removed from the container.

Further, the right lower adhesion layer 3a, left lower adhesion layer 3b, right upper adhesion layer 3e, lower edge adhesion layer 3c and/or lower edge adhesion layer 3d of the upper portion, may be formed on the inside of the boundary or the cutting line 19 along the peripheral edge of the tack-label 1, and the photo-adhesive 3 may be locally applied onto the back surface only on the inside of the portions that are to be cut. Therefore, the sheet 2 for labels that are taken up by the waste roller, is easily peeled off from the release sheet 4 and the tack-labels 1 that are half-cut by the half-die-cut device 12.

Further, the right lower adhesion layer 3a, left lower adhesion layer 3b, right upper adhesion layer 3e, lower edge adhesion layer 3c and/or lower edge adhesion layer 3d of the upper portion, may be formed protruding toward the outside of the boundary or the cutting line 19 that is to be cut of the tack-label 1, and the photo-adhesive 3 may be locally applied protruding toward the outside of the portion that is to be cut. Therefore, the tack-label 1 that is stuck is not easily peeled off from the container.

The right lower adhesion layer 3a, left lower adhesion layer 3b, right upper adhesion layer 3e, lower edge adhesion layer 3c and/or lower edge adhesion layer 3d of the upper portion, are printed in a linear shape or in a planar shape, but may also be printed in the shape of dots, broken lines, mosaic, striped pattern, checker wise or polka dots.

Further, the cutting line 19 surrounding the tack-label 1 is a broken line (including perforated line) or a continuous (half-cut) line, and may be half-cut such that an excess of sheet 2 for labels remains on the outer edge of the cutting line 19. In other words, a line for cutting a broken line or a solid line may further be formed on the inside of the cutting line 19 of the tack-label 1, and the sheet 2 for labels and the release sheet 4 may be cut in a shape larger than the tack-label 1, and the photo-adhesive 3 is locally printed onto only the sheet 2 for labels nearly on the inside of the portions that are to be cut. Therefore, the peripheral edges of the tack-label 1 are protected.

In the above half-cutting, only the sheet 2 for labels is cut in the shape of the tack-label 1 or in a shape larger than the tack-label 1. Here, however, all-cutting may be employed to cut the sheet 2 for labels as well as the release sheet 4 in the shape of the tack-label 1 or in a shape larger than the tack-label 1.

The tack-label 1 is peeled off from the release sheet 4 and is stuck to the outer surface of the container.

(7) Material of the Tack-label 1

The sheet 2 for labels and the release sheet 4 are made of a plastic film, a synthetic paper, a paper, a foil, an evaporated paper (including metallized paper), a vacuum evaporated plastic film (including vacuum metallized plastic film), a mixture thereof, or a laminate thereof. The plastic film may be, for example, a polyester film such as of polyethylene terephthalate, a polyolefin film such as of polypropylene, a single layer film such as of polyvinyl chloride, polystyrene, polyamide or cellophane, a multi-layer film thereof, or a vacuum evaporation film.

The sheet 2 for labels and/or the release sheet 4 may be transparent or opaque as described above, and are mono-axially or bi-axially oriented (including stretched) films or non-oriented (including non-stretched) films or are, preferably, thermally oriented (including contractibility) shrink (including ductile) films (particularly, polyester films, polystyrene films, polypropylene films, or polyvinyl chloride films) In this case, it is desired that the release sheet 4 and the sheet 2 for labels have the same coefficient of shrinkage (including contraction).

When the sheet 2 for labels or the tack-label 1 is a thermally shrink film and the direction of shrinkage (including contraction) or orientation (including ductility) is in agreement with the circumferential direction on the surface of the cylindrical pole (square pole, circular cylinder or square cylinder), then, the tack-label 1 can be thermally heat-shrunk along the circumferential direction, and the tack-label 1 is firmly stuck to the container by the application of heat. When the sheet 2 for labels has a biaxial or multi-axial shrink orientation (including thermal ductility), the tack-label undergoes the heat shrink (including thermal contraction) not only in the circumferential direction and in the direction of opening the cap portion but also in a longitudinal direction at right angles with the above direction and in the tilted directions from the above direction.

Besides, the photo-adhesive 3 (including photo-adhesive layer) or the right lower adhesion layer 3a, left lower adhesion layer 3b and right upper adhesion layer 3e are printed linearly or like dots at the head and at the tail of the tack-label 1 in the direction of thermal shrinkage, which is in a direction at right angles with the direction of orientation (including ductility). In other words, the adhesion layers 3a, 3b and 3e are formed linearly or like dots on only the portions that are overlapped at the same positions when wound on the container. Owing to the thermal orientation of the tack-label 1, therefore, the tack-label 1 stuck to the container is not loosened, wrinkled or forcibly oriented.

The sheet 2 for labels has a thickness of, generally, 15 to 200 μm, desirably, 25 to 100 μm and, more desirably, 35 to 50 μm, or may have a thickness of not smaller than 200 μm, without impairing the handling and operability of the tack-label 1.

Due to the anilox rolls 50 to 55L in a flexography printing machine, the UV adhesive precursor ink is transited into a convex plate of flexography resin, and the photo-adhesive 3 is applied maintaining a constant thickness (6 to 8 g/m²). The photo-adhesive 3 that is printed is completely shut off from the air or oxygen, is irradiated with ultraviolet rays, and turns into the photo-adhesive having uniform, stable and strong stickiness. A gravure plate (including block) or a screen plate (including block) may be used instead of the convex plate (including block) of flexography resin. The UV adhesive precursor ink is obtained by adding a hydrocarbon resin, a polymerization inhibitor, an antioxidant and a photo-polymerization initiator to an acrylic monomer or oligomer.

The acrylic monomer or oligomer which is the material of the photo-adhesive 3 may be an alkylester acrylate such as ethyl acrylate, butyl acrylate, or 2-ethylhexyl acrylate. In addition to the water-soluble or water-insoluble acrylic adhesives, the material of the photo-adhesive 3 may be further mixed, depending upon the cases, with an alkylester methacrylate such as butyl methacrylate or 2-ethylhexyl methacrylate, and may further be copolymerized with a monomer containing carboxyl group or monomer containing hydroxyl group. The material of the photo-adhesive 3 may further be a rubber-type adhesive or a silicone-type adhesive.

The photo-adhesive 3 is applied in an amount per a square centimeter of 4.5 to 16 grams, desirably, 5 to 12 grams and, more desirably, 6 to 8 grams. The photo-adhesive 3 has a thickness of 3 to 100 μm, desirably, 7 to 70 μm and, more desirably, 10 to 40 μm, or may have a thickness of not smaller than 100 μm.

The amount of irradiation per a square meter of ultraviolet rays from the ultraviolet ray lamp 8 with which the photo-adhesive 3 is irradiated, is 14 to 60 mJ/m², desirably, 17 to 45 mJ/m² and, more desirably, 20 to 30 mJ/m². With the air or oxygen completely shut off, the adhesion (including sticking force) of the photo-adhesive 3 does not almost change even after the irradiation with light, and the photo-adhesive 3 undergoes a nearly complete polymerization reaction and a cross-linking reaction.

After having been polymerized and cross-linked, the photo-adhesive 3 that has become sticky exhibits the adhesion that does not change, and the tack-label 1 is stably stuck to the container. After having been completely polymerized and cross-linked, the photo-adhesive 3 remains chemically stable. Accordingly, the photo-adhesive 3 is not degenerated or deteriorated.

The material of the release sheet 4 and/or the sub-release sheet 5 for pre-adhesion may be a plastic film, a synthetic paper, a paper, a mixture thereof, or a laminate thereof. As a film that shuts off oxygen, that permits ultraviolet rays to pass through and that peels off the adhesion layer, there can be used a monoaxially oriented film, a biaxially oriented film, a non-oriented film, or a laminated film thereof. For example, as a plastic film which shuts off oxygen to a high degree, there can be used an EVOH (evohr) film, a PVCD (polyvinylidene copolymer) film, a PAN (acrylonitrile copolymer) film or a ONY (nylon) film. As a plastic film which permits ultraviolet rays to pass through to a high degree, there can be used a PVA (Poval) film, an OPP (polypropylene) film or a PE (polyethylene) film.

As required, the release sheets 4 and 5 may be treated for their surfaces so as to be imparted with peeling property (coating by remover). The release sheets 4 and 5 have a thickness of, generally, 20 to 80 μm, and desirably, 40 to 80 μm without impairing the handling and operability of the tack-label 1.

The material of the ink forming the ink layer 16 (16a and 16b) is obtained by adding pigments and additives to a monomer component or an oligomer component. The monomer component may be a 2-hydroxyacyl methacrylate, an acrylic hydroxybutyl, an acrylic cyclohexyl or a dicyclopentadiene acrylate. The oligomer component may be a urethane acrylate, an epoxy acrylate, a polyester acrylate or a polyether acrylate. The additives may include a photo-polymerization initiator, a photo-polymerization promoter, a stabilizer, a wax, a mist adsorptive, a lubricant and the like.

(8) Experimental Results of Adhesion

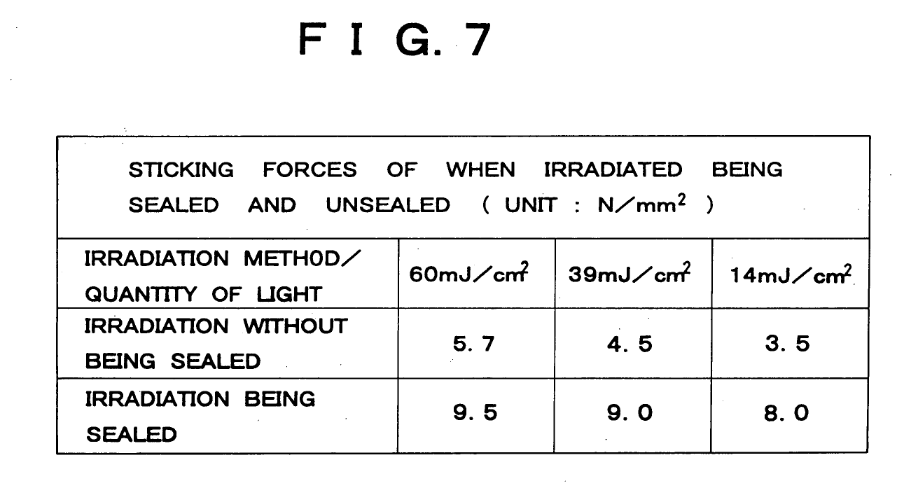

FIG. 7 illustrates experimental results of correlation between the amount of ultraviolet ray irradiation and the adhesion of when the photo-adhesive 3 is hermetially sealed and when the photo-adhesive 3 is not hermetically sealed. Numerals represent adhesion (N: newtons) per 25 mm². When the photo-adhesive 3 is hermetically sealed, an adhesion of 9.5 N/25 mm² is obtained under the irradiation amount of 60 mJ/cm², an adhesion of 9.0 N/mm² is obtained under the irradiation amount of 39 mJ/cm², and an adhesion of 8.0 N/mm² is obtained under the irradiation amount of 14 mJ/cm².

When the photo-adhesive 3 is irradiated with ultraviolet rays without being hermetically sealed but being exposed to oxygen in the air, on the other hand, a adhesion of 5.7 N/25 mm² is obtained under the irradiation amount of 60 mJ/cm², a adhesion of 4.5 N/mm² is obtained under the irradiation amount of 39 mJ/cm², and a adhesion of 3.5 N/mm² is obtained under the irradiation amount of 14 mJ/cm². Therefore, a strong adhesion is produced when the photo-adhesive 3 is hermetically sealed.

Besides, when the adhesive is irradiated with light while being in contact with oxygen in the air, the adhesion varies over a range of from 5.7 to 3.5 N/25 mm² under the irradiation amounts of 60 to 14 mJ/cm². When the adhesive is irradiated with light in the hermetically sealed state, the adhesion varies within a range as narrow as from 9.5 to 8.0 N/25 mm² under the irradiation amounts of 60 to 14 mJ/cm , i.e., the adhesion is stable and varies little.

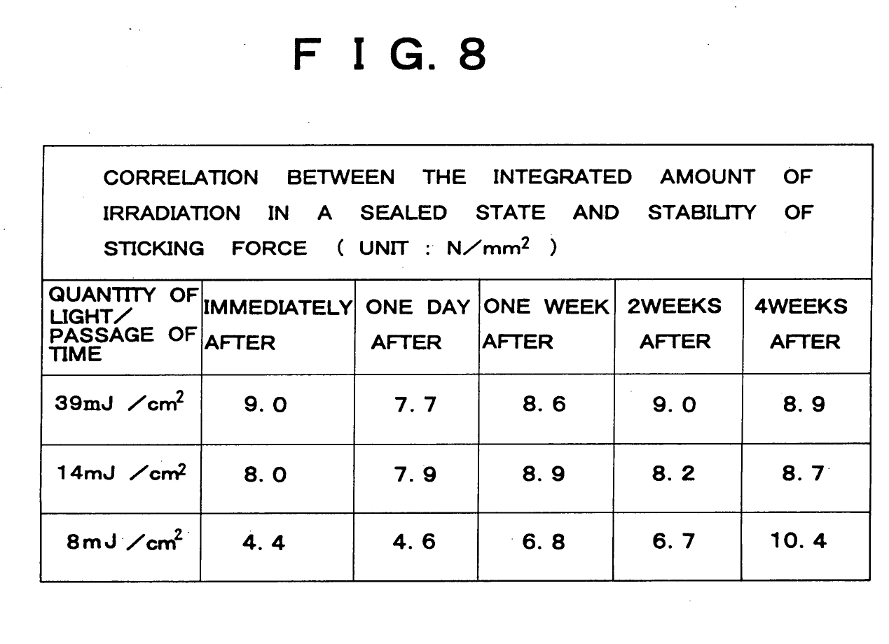

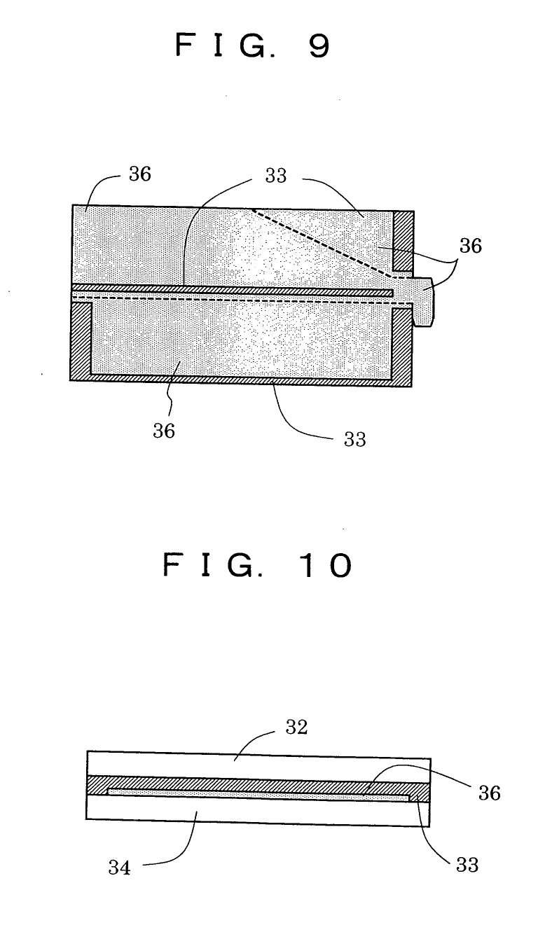

FIG. 8 illustrates experimental results of correlation between the amount of ultraviolet ray irradiation and a change in the adhesion with the passage of time of when the photo-adhesive 3 is hermetically sealed. When the amount of irradiation is 39 mJ/cm², the adhesion is 9.0 N/25 mm² immediately after the irradiation, 7.7 N/25 mm² after one day, 8.6 N/25 mm² after one week, 9.0 N/25 mm² after two weeks, and 8.9 N/25 mm² after four weeks.

Similarly, when the amount of irradiation is 14 mJ/cm², the adhesion is 8.0 N/25 mm² immediately after the irradiation, 7.9 N/25 mm² after one day, 8.9 N/25 mm² after one week, 8.2 N/25 mm² after two weeks, and 8.7 N/25 mm² after four weeks.

When the amount of irradiation is 8 mJ/cm², the adhesion is 4.4 N/25 mm² immediately after the irradiation, 4.6 N/25 mm² after one day, 6.8 N/25 mm² after one week, 6.7 N/25 mm² after two weeks, and 10.4 N/25 mm² after four weeks.

Even when the amount of irradiation is 8 mJ/cm², the adhesion is 10.4 N/25 mm² after four weeks. Therefore, when a gradually increasing adhesion is required, the irradiation amount of as small as 8 mJ/cm² will suffice the need. However, a change in the adhesion is not desirable from the stability in the state of sticking the tack-label 1.

When the adhesion is thus greatly varying, the photo-adhesive 3 has not been completely polymerized or cross-linked, has not still been chemically stabilized, and is subject to be degenerated or deteriorated.

When the amount of irradiation is not smaller than 10 mJ/cm², on the other hand, the photo-adhesive 3 is completely polymerized or cross-linked, is chemically stabilized, and is not subject to be degenerated or deteriorated.

Accordingly, the amount of irradiation is not smaller than 10 mJ/cm², say, 10 to 50 mJ/cm², desirably, 14 to 40 mJ/cm², and more desirably, 20 to 30 mJ/cm². The photo-adhesive 3 is applied in an amount of 4.5 to 16 grams, desirably, 5 to 8 grams and, more desirably, 6 to 7 grams per a square centimeter.

The invention is not limited to the above embodiment only but can be modified in a variety of ways without departing from the gist and scope of the invention. For example, the container to which the tack-label 1 is stuck may be a plastic bottle such as a PET bottle, a glass bottle or a metallic container. The tack-label 1 may have any shape and any size, and the surfaces of the containers to which the tack-label 1 is to be stuck may be surfaces of circular poles (circular cylinder, square pole, and square cylinder) as well as convex surfaces and plane surfaces.

The turn bar 11 may be omitted. In this case, various devices in the subsequent stages following the turn bar 11, such as half-die-cut device 12 and waste roller 13 in FIG. 1, UV-cut print roller 14, ink print roller 15, half-die-cut device 12 and waste roller 13 in FIG. 2, and adhesive pattern print roller 7, ultraviolet ray lamp 8, chill roller 9, nipping rollers 10, release sheet 4 and sub-release sheet 5 for pre-adhesion in FIG. 3, are reversed upside down.

The sub-release sheet 5 for pre-adhesion, release sheet 4 and sheet 2 for labels in FIG. 3 may be made of any materials provided they are capable of shutting off oxygen in the air and components detrimental to the sticking.

According to the present invention as described above in detail, a pattern of the label is printed every after a predetermined interval, the photo-adhesive without stickiness is locally printed depending on the size of the label every after a predetermined interval, and the release sheet is intimately adhered onto the surface of the sheet for labels on which the photo-adhesive has been printed, so that the photo-adhesive that is printed is shut off from oxygen in the air. Further, the photo-adhesive is irradiated with light to impart stickiness thereto, and the sheet for labels or the release sheet is cut every after the pattern of the label that is printed. Therefore, the sheet is not loosened, is not wrinkled or is not forcibly oriented, making it possible to favorably produce the sheet and the tack-labels. Further, the adhesion layer that is formed needs not be covered with a masking layer, and is not wasted since it is not covered with the masking layer. Besides, no masking layer is needed. Further, the photo-adhesive is imparted with stickiness upon the irradiation with light in a state of being shut off from oxygen in the air. Therefore, a strong adhesion is obtained which remains stable without changing over extended periods of time.

1. A method of producing tack-labels comprising: printing a pattern of the label every after a predetermined interval, and locally printing a photo-adhesive without stickiness every after a predetermined interval depending on the size of the label on a longitudinal sheet for labels which tack-labels are product of;
intimately adhering a release sheet onto the surface of the sheet for labels on which the photo-adhesive has been printed and shutting off the photo-adhesive that is printed from oxygen in the air;
irradiating the photo-adhesive with light and making the photo-adhesive imparted stickiness, and cutting the sheet for labels or the release sheet after every pattern of the label that is printed.

2. An apparatus for producing tack-labels comprising:
system unit for printing a pattern of the label every after a predetermined interval, and locally printing a photo-adhesive without stickiness every after a predetermined interval depending on the size of the label on a longitudinal sheet for labels which tack-labels are product of;
system unit for intimately adhering a release sheet onto the surface of the sheet for labels on which the photo-adhesive has been printed and shutting off the photo-adhesive that is printed from oxygen in the air;
system unit for irradiating the photo-adhesive with light and making the photo-adhesive imparted stickiness, and
system unit for cutting the sheet for labels or the release sheet after every pattern of the label that is printed.

3. The method of producing tack-labels comprising according to the claim 1,
the photo-adhesive is printed on a sheet for labels in the direction of width of a sheet for labels, the length or area of a portion where photo-adhesion formed is smaller than the length or area of a portion where the photo-adhesive has not been formed in the direction in which a sheet for labels is fed/in the longitudinal direction of the a sheet for labels,
or the length or area of a portion where photo-adhesion formed is larger than the length or area of a portion where the photo-adhesive has not been formed in the direction of width of a sheet for labels.

4. The method of producing tack-labels comprising according to the claim 1;
the photo-adhesive is locally applied on the nearly inside of the boundary or cutting line of a sheet for labels only.

5. The method of producing tack-labels comprising according to the claim 1;
the photo-adhesive is applied in an amount per a square centimeter of 4.5 to 16 grams, desirably, 5 to 8 grams and, more desirably, 6 to 7 grams,
the amount of irradiation is 10 to 50 mJ/cm², desirably, 14 to 40 mJ/cm² and, more desirably 20 to 30 mJ/cm²,
the adhesion of the photo-adhesive does not almost change even after the irradiation with light,
the photo-adhesive undergoes a nearly complete cross linking reaction.

6. The method of producing tack-labels comprising according to the claim 1;
an ultraviolet ray-shielding agent is contained into, is applied onto, or an ultraviolet ray-shielding sheet is adhered on a sheet for labels, a release sheet, or the pattern of label pattern to be printed,
or the substance which is easy to deteriorate and degenerate by ultraviolet rays is placed in a container to which the sheet for labels is stuck.

7. The method of producing tack-labels comprising according to the claim 1;
the label is stuck to the surface of a container which is a circular pole, square pole, circular cylinder or square cylinder,
the sheet for labels has a mono-axial or multi-axial thermal shrinkage or orientation along the circumferential on the surface of the circular pole, the square pole, the circular cylinder or the square cylinder,
or the photo-adhesive is printed linearly or like dots on the sheet for labels in a direction at right angles with the direction of orientation.

8. The method of producing tack-labels comprising according to the claim 1;
a photo-adhesive is printed at the head and at the tail of the tack-label along a direction of thermal shrinkage,
or the photo-adhesive is printed on the portions that are overlapped at same positions when the sheet for labels is wound on a container.

9. The method of producing tack-labels comprising according to the claim 1;
the release sheet is transparent and permits light to pass through, light irradiates through the release sheet, and the photo-adhesive imparts stickiness.

10. The method of producing tack-labels comprising according to the claim 1;
the release sheet is transparent and permits light to pass through, after irradiation with light to impart stickiness to the photo-adhesive, the release sheet which permits light to pass through is peeled off from a sheet for labels, and the release sheet which is opaque and does not permit light to pass through is intimately adhered onto the sheet for labels.

11. The method of producing tack-labels comprising according to the claim 10;
the release sheet is intimately adhered onto the sheet for labels and after irradiation with light the release sheet is peeled off from the sheet for labels, the release sheet is an endless form and a series of successive the intimately adhering to the sheet for labels and being peeled off from the sheet for labels are repeated.

12. The method of producing tack-labels comprising according to the claim 1;
the sheet for labels is transparent and permits light to pass through, light irradiates through the sheet for labels, the photo-adhesive imparts stickiness.

13. The method of producing tack-labels comprising according to the claim 1;
the light is ultraviolet rays, and the photo-adhesive imparts stickiness by irradiation with ultraviolet rays, and the release sheet or the sheet for labels is a film which permits ultraviolet rays to pass through but does not permit oxygen in the air to pass through.

14. The method of producing tack-labels comprising according to the claim 1;
the light is visible rays, and the photo-adhesive imparts stickiness by irradiation with visible rays, and the release sheet or the sheet for labels is a film which permits visible rays to pass through but does not permit oxygen in the air to pass through.

15. The method of producing tack-labels comprising according to the claim 1;
the light is electron beams, and the photo-adhesive imparts stickiness by irradiation with electron beams, and the release sheet or the sheet for labels is a film which permits electron beams to pass through but does not permit oxygen in the air to pass through.

16. The method of producing tack-labels comprising according to the claim 1;
a surface on which the pattern is printed is the same as a surface on which the photo-adhesive is printed, or is different from the surface on which the photo-adhesive is printed.

17. The method of producing tack-labels comprising according to the claim 1;
in the cutting, only the sheet for labels is cut in the shape of the tack-label, both the sheet for labels and the release sheet are cut in the shape of the tack-label or in a shape larger than the tack-label.

18. The method of producing tack-labels comprising according to the claim 1;
a line as a cutting line further is formed on the inside of the cutting line, and the inner cutting line is a broken line or a solid line.

19. The method of producing tack-labels comprising according to the claim 1;
the label is stuck to a container which is a circular pole, square pole, circular cylinder or square cylinder, the photo-adhesive is completely cross-linked and polymerized by irradiation with light, and the photo-adhesive is chemically stable and is not degenerated or is not deteriorated.

20. The method of producing tack-labels comprising according to the claim 1;
a surface on which the pattern of the label is printed is the same as a surface on which the photo-adhesive is printed, the printed pattern of the label and the printed photo-adhesive are stuck to a surface of a transparent container, the surface on which the pattern is printed of the label can be watched through the transparent container, and the surface on which the pattern of label is printed is protected by coating with the label.

21. Tack-labels produced by the method of producing tack-labels comprising according to the claim 1.
